(19) United States
(12) Patent Application Publication
(10) Pub. No.: US 2025/0200893 A1
(43) Pub. Date: Jun. 19, 2025

(54) CONTEXTUAL TIME-BASED DIGITAL REPRESENTATIONS

(71) Applicant: Meta Platforms Technologies, LLC, Menlo Park, CA (US)

(72) Inventor: Andrew Garrod Bosworth, San Mateo, CA (US)

(21) Appl. No.: 18/905,578

(22) Filed: Oct. 3, 2024

Related U.S. Application Data
(60) Provisional application No. 63/611,872, filed on Dec. 19, 2023.

(51) Int. Cl. G06T 17/20; G06F 16/332; G10L 13/02

(52) U.S. Cl. CPC G06T 17/20; G06F 16/3329; G10L 13/02

(57) ABSTRACT

Various aspects of the subject technology relate to systems, methods, and machine-readable media for generating time-based interactive digital representations of a subject. Various aspects may include receiving a request for generating the interactive digital representations, wherein the request specifies the subject. Aspects may also include determining a time period covering a time span associated with the request. Aspects may also include retrieving contextual information associated with the subject and restricted by the time period. Aspects may also include generating, based on the contextual information, a model representing a persona of the subject in the time period. Aspects may include outputting an interactive digital representation of the model in a user interface (e.g., a conversational agent in a messaging application or avatar in a virtual environment), enabling user interactions with the model.

### CROSS-REFERENCE TO RELATED APPLICATIONS

This application claims the benefit of U.S. Provisional Patent Application No. 63/611,872, to Bosworth filed on Dec. 19, 2023, the disclosures of all of these applications and patents are incorporated by reference herein.

### TECHNICAL FIELD

The present disclosure generally relates to generating digital representations of target persons at a moment or moments in chronological time of their lives, and more particularly to training models to learn behaviors and personalities based on contextual information associated with the target persons at those times to encapsulate a digital representation in accordance with predictions made based on a target person baseline. Users may interact with the digital representations using, for example, a personified chatbot designed to reflect the target person's persona.

### BACKGROUND

Enhancing virtual representations has been increasingly focal in virtual reality/augmented reality (VR/AR) applications, effecting social presence and the demand for varying uses for digital representations. Generative artificial intelligence (AI) models are trained on visual data (e.g., images and videos) to generate human-like avatars (e.g., “codec” avatars) with a focus on physical features to provide an avatar that moves and looks like a specified person. Traditional methods of digital representations in virtual environments enable real-time avatar generation and customization features. Large language models (LLMs) are used in the field of generative AI to understand text and generate new content and produce text. However, these LLMs are trained on large datasets that are not designed to generate text based on a specified person.

### SUMMARY

The subject disclosure provides for systems and methods for generating, with the consent of a user, time-based digital models representing a person in one or several periods of time. The models can be rendered as digital representations as permitted by the user and applied to one or more interactive media applications (e.g., messaging application, mixed reality, extended reality, or extra reality environment). The models include AI generative models and language models trained based on contextual information of a specified person or subject within a set time period. The digital representations are designed to interact elements that embody a persona of the specified person in the set time period. The digital representations may be stored with user consent and used as a time capsule reference to the specified person in the set time period.

According to one embodiment of the present disclosure, a computer-implemented method for generating time-based models is provided. The method includes receiving a request, at a client device, specifying a subject. The method also includes determining a time period covering a time span associated with the request. The method also includes retrieving, from at least the client device, contextual information including at least text data associated with the subject, the contextual information restricted by the time period. The method also includes generating, based on the contextual information, a model representing characteristics of the subject. The method also includes displaying an interactive digital representation of the model in a user interface of the client device.

According to one embodiment of the present disclosure, a system is provided including a processor and a memory comprising instructions stored thereon, which when executed by the processor, causes the processor to perform a method for generating time-based models. The method includes receiving a request, at a client device, specifying a subject. The method also includes determining a time period covering a time span associated with the request, wherein the time period is made up of a present, past, or future period of time. The method also includes retrieving, from at least the client device, contextual information including at least text data associated with the subject, and the contextual information restricted by the time period. The method also includes generating, based on the contextual information, a model representing characteristics of the subject. The method also includes displaying an interactive digital representation of the model in a user interface of the client device.

According to one embodiment of the present disclosure, a non-transitory computer-readable storage medium is provided including instructions (e.g., stored sequences of instructions) that, when executed by a processor, cause the processor to perform a method generating time-based models. The method includes receiving a request, at a client device, specifying a subject. The method also includes determining a time period covering a time span associated with the request, wherein the time period is made up of a present, past, or future period of time. The method also includes retrieving, from at least the client device, contextual information including at least text data associated with the subject, and the contextual information restricted by the time period. The method also includes generating, based on the contextual information, a model representing characteristics of the subject. The method also includes displaying an interactive digital representation of the model in a user interface of the client device, wherein the interactive digital representation is configured to generate responses to text queries in accordance with predications made based on the model.

According to one embodiment of the present disclosure, a non-transitory computer-readable storage medium is provided including instructions (e.g., stored sequences of instructions) that, when executed by a processor, cause the processor to perform a method for generating an interactive digital representation as a chatbot. The method includes generating a message thread in a social platform between a user of the client device and the interactive digital representation. The method also includes rendering at least a portion of the interactive digital representation in an image of the subject within the message thread. The method also includes receiving text queries input via the message thread from the user. The method also includes generating predicted responses to the text queries based on the model of the subject. The method also includes outputting the predicted responses to the text queries in the message thread in a conversation format.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a network architecture used to implement digital representation generation, according to some embodiments.

FIG. 2 is a block diagram illustrating details of devices used in the architecture of FIG. 1, according to some embodiments.

FIG. 3 is a block diagram illustrating an overview of operations for generating digital representation related to a user, according to one or more embodiments.

FIG. 4 illustrates a system configured for generating time-based interactive digital representations, in accordance with one or more implementations.

FIG. 5 is an example flow diagram for generating time-based interactive digital representations, according to certain aspects of the present disclosure.

FIG. 6 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a thorough understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

The disclosed system addresses a problem in mixed reality tied to computer technology, namely, the technical problem of enabling access to digital representations of a target person in a specified period of time (e.g., at a specific age of the target person) using an AI model that leverages LLMs to predict responses, actions, expressions, or the like in accordance with the target person. According to some embodiments, a base generative AI model is trained with aspects of a target person's physical appearance, mannerisms, and information about their personality to capture the target person, including their appearance, mannerisms, and personality at a certain moment in life and generate a corresponding digital representation. The digital representation, for example, is configured to respond, speak, react, move, interact, etc., like the target person as they would have in the specified period of time. The digital representations, according to embodiments, provide time capsules of persons that users can engage with (e.g., via chat using an AI agent) or in a mixed reality or virtual environment. The digital representations may be rendered using avatars (e.g., codec avatars). The avatars may be human-like and physically resemble the target person.

Traditional methods of digital representations in virtual environments enable real-time avatar generation and customization features. However, these methods are not able to provide digital representations in accordance with predictions made based on an acquired person baseline. Therefore, to further develop digital representations, there is a need for AI generative models that can leverage LLMs to learn a specified person, not just based on physical characteristics, but based on contextual information (e.g., their speech, personality, and mannerisms) to encapsulate the specified person, e.g., at a specified time (or period of time in their life). This will change and enhance the way people interact in the digital world. The disclosed system solves this technical problem by providing a solution also rooted in computer technology, namely, by providing a model trained on a target person's words/text, contextual information, social information, visual data (e.g., images and videos of the target person) during a restricted time period. A digital representation (or avatar) may be generated based therefrom, encapsulating a virtual version of the target person in a slice of time. Virtual versions may be stored and used as representations of a person in a period of their life. As a non-limiting example, embodiments can provide users with access to visit and engage with their younger selves as they age and/or give future generations access to elders.

Aspects of the present disclosure may include or be implemented in a messaging application. Users may have conversations in, for example, a message thread via the messaging application with an AI conversational agent, chatbot, or the like, corresponding to a generated digital representation of a target person. For example, users may ask the AI agent questions in the message thread which will generate text responses in line with the digital representation of the target person using the trained AI model. Details of the digital representation including, but not limited to, identity information (e.g., name of the target person), life stage, relationship status, time period for which the digital representation reflects (e.g., the year 1998), environmental information (e.g., location), other contextual data on the target person (e.g., height, age of the target person, etc.) may be stored and accessed via the message application. In some implementations, a characterization of the digital representation is generated to summarize a persona of the target person in the time period. The message thread may further include a visual of the digital representation resembling the target person. The visual may be configured to react and perform motions (e.g., facial expression, hand gestures, etc.) in accordance with the target person based on predictions made using the trained AI model. The message thread may further include auditory feedback in a voice, tone, and/or idiolect of the target person. The messaging application may be web-based and/or accessed on a client device, such as a computer, mobile device, and/or AR device (e.g., headset).

Aspects of the present disclosure are directed to generating digital representations, such as codec avatars, that may be rendered and interacted with in mixed reality environments. For example, a mixed reality environment may be a shared artificial reality environment, a virtual reality (VR), an augmented reality environment (AR), a mixed reality (MR) environment, a hybrid reality environment, a non-immersive environment, a semi-immersive environment, a fully immersive environment, and/or the like. The mixed reality environments may also include artificial collaborative gaming, working, and/or other environments which include modes for interaction between various people or users in the artificial environments. The mixed reality environments of the present disclosure may provide elements that enable users to navigate (e.g., scroll) in the environments via function expansions in the user's wrist, such as via pinching, rotating, tilting, and/or the like. For example, the degree that the user's wrist is tilted can correspond to how quickly a scrollable list is scrolled through in the mixed reality environments (e.g., more tilt results in faster scrolling while less tilt results in slower scrolling). As used herein, “real-world” objects are non-computer generated and artificial or VR objects are computer generated. For example, a real-world space is a physical space occupying a location outside a computer and a real-world object is a physical object having physical properties outside a computer. For example, an artificial or VR object may be rendered and part of a computer-generated mixed reality environment.

The original applicant acknowledges that the selection and development of technologies in the dynamic field of artificial intelligence are determined based on their utility and relevance for both the applicant and its users. Consequently, it is possible that the systems and methods detailed in this document may not have been, or may not be in the future, employed or developed by the original applicant in the realm of artificial intelligence. Additionally, any implementation or utilization of these systems and methods by the original applicant adheres to its privacy policies, which are designed to uphold and prioritize user privacy in the context of artificial intelligence, aiming to meet or exceed relevant government and legal requirements.

In cases where the implementation or use of these systems and methods involves the processing of user personal information within the mixed reality environment, such processing occurs in accordance with the privacy policies, under a valid legal mechanism, and respecting user privacy settings or preferences. The original applicant also expresses its intention for these systems and methods, if adopted by other entities in the field of artificial intelligence, to comply with privacy policies and practices aligned with the objective of respecting user privacy within the artificial intelligence domain.

Embodiments of the disclosed technology may include or be implemented in conjunction with a mixed reality system. Mixed reality is a form of reality that has been adjusted in some manner before presentation to a user, which may include, e.g., extended reality, extra reality (XR), VR, AR, MR, hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional effect to the viewer). Additionally, in some implementations, mixed reality may be associated with applications, products, accessories, services, or some combination thereof, that are, e.g., used to create content in a mixed reality and/or used in (e.g., perform activities in) the mixed reality. The mixed reality system that provides the mixed reality content may be implemented on various platforms, including a head-mounted display (HMD) connected to a host computer system, a standalone HMD, a mobile device or computing system, a “cave” environment or other projection system, or any other hardware platform capable of providing mixed reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a users' eye is partially generated by a computing system and partially composes light reflected off objects in the real world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Mixed reality,” “artificial reality,” “extra reality,” or “XR,” as used herein, refers to any of VR, AR, MR, or any combination or hybrid thereof.

### Example Architecture

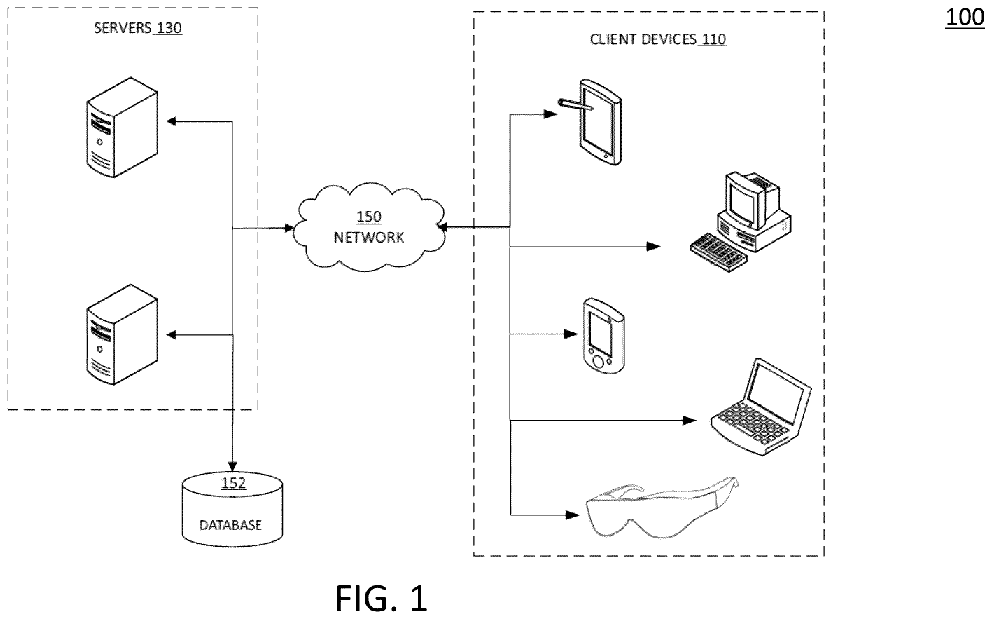

Several implementations are discussed below in more detail in reference to the figures. FIG. 1 illustrates a network architecture 100 used to implement digital representation generation, according to some embodiments. Architecture 100 may include server(s) 130 and a database 152, communicatively coupled with one or more client devices 110 via a network 150. Any one of servers 130 may host an application (e.g., a messaging application) running on client devices 110, used by one or more of the participants in the network. Servers 130 may include a cloud server or a group of cloud servers. In some implementations, servers 130 may not be cloud-based (i.e., platforms/applications may be implemented outside of a cloud computing environment) or may be partially cloud-based. Client devices 110 may include any one of a laptop computer, a desktop computer, or a mobile device such as a smart phone, a handheld device, video player, or a tablet device.

In some embodiments, client devices 110 may include a headset or other wearable device (e.g., a virtual reality or augmented reality headset or smart glass). In various implementations, client devices 110 can communicate over wired or wireless channels to distribute processing and/or share data. Architecture 100 can create, administer, and provide interaction modes for a shared mixed reality environment (e.g., collaborative artificial reality environment) at client device 110, such as for communication via XR or other communication elements. The interaction modes can include various modes for various audio conversation, textual messaging, communicative gestures, control modes, and other communicative interaction, etc., for each user of the client device 110.

The database(s) 152 may store backup files from the application including, for example, generated digital representations, training data, or the like. The database(s) 152 may logically form a single unit or may be part of a distributed computing environment encompassing multiple computing devices that are located within their corresponding server, located at the same, or located at geographically disparate physical locations. For example, contextual information may be stored in the database(s) 152 and may comprise information such as location, type of XR element being rendered, metadata associated with a user and/or target person, social platform/messaging application data, and/or the like.

Network 150 can include, for example, any one or more of a local area network (LAN), a wide area network (WAN), the Internet, a mesh network, a hybrid network, or other wired or wireless networks. Further, network 150 can include, but is not limited to, any one or more of the following network topologies, including a bus network, a star network, a ring network, a mesh network, a star-bus network, tree or hierarchical network, and the like. Network 150 may be the Internet or some other public or private network. Client computing devices can be connected to network 150 through a network interface, such as by wired or wireless communication. The connections can be any kind of local, wide area, wired, or wireless network, including the network 150 or a separate public or private network.

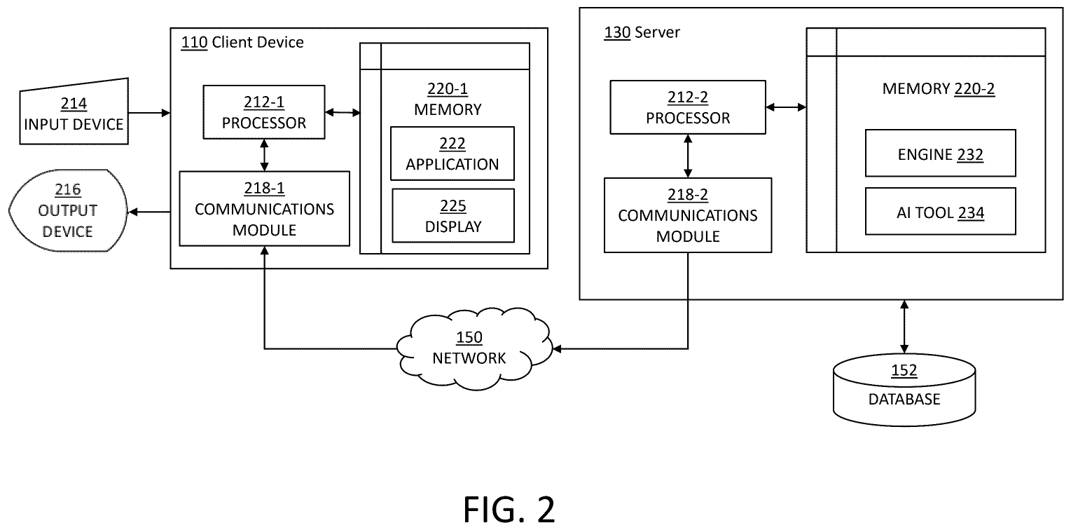

FIG. 2 is a block diagram 200 illustrating details of a client device 110 and server 130 used in a network architecture as disclosed herein (e.g., architecture 100), according to some embodiments. Client device 110 and servers 130 are communicatively coupled over network 150 via respective communications modules 218-1 and 218-2 (hereinafter, collectively referred to as “communications modules 218”). Communications modules 218 are configured to interface with network 150 to transmit or receive information, such as user data, messaging history, user input data, and/or the like to other devices on the network 150. Communications modules 218 can be, for example, modems or Ethernet cards, and may include radio hardware and software for wireless communications (e.g., via electromagnetic radiation, such as radiofrequency-RF-, near field communications-NFC-, Wi-Fi, and Bluetooth radio technology).

Client device 110 may be coupled with an input device 214 and with an output device 216. A user may interact with client device 110 via the input device 214 and the output device 216. Input device 214 may include a mouse, a keyboard, a pointer, a touchscreen, a wearable input device (e.g., a haptics glove, a bracelet, a ring, an earring, a necklace, a watch, etc.), a microphone, a controller, a joystick, a virtual joystick, a camera, a touchscreen display that a user may use to interact with client device 110, or the like. In some embodiments, input device 214 may include cameras, microphones, and sensors, such as touch sensors, acoustic sensors, inertial motion units-IMUs-and other sensors configured to provide input data. Output device 216 may include a screen display (e.g., an LCD display screen and/or LED display screen), a touchscreen, a speaker, a projector, holographic, or augmented reality display (such as a heads-up display device or a head-mounted device), and/or the like. According to embodiments, the client device 110 may be used to scan a target person and retrieve data associated with the target person from the client device or an external data source.

Client device 110 may also include a processor 212-1, configured to execute instructions stored in a memory 220-1, and to cause client device 110 to perform at least some operations in methods consistent with one or more embodiments and some operations are offloaded to a core processing component or server 130. Memory 220-1 may further include an application 222 and a display 225, configured to run in client device 110 and couple with input device 214 and output device 216. The application 222 may be downloaded by the user from servers 130 and may be hosted by servers 130. The application 222 includes specific instructions which, when executed by processor 212-1, cause operations to be performed according to methods described herein. In some embodiments, the application 222 runs on an operating system (OS) installed in client device 110. In some embodiments, application 222 may run out of a web browser. In some embodiments, the processor is configured to control a graphical user interface (GUI) or display 225 for the user of one of client devices 110 accessing the server of the social platform. Data and files associated with the application 222 may be stored in database(s) 152.

Servers 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” In some implementations, the servers 130 can be used as part of a social network/platform implemented via the network 150. Processors 212 (e.g., central processing units (CPUs), graphical processing units (GPUs), holographic processing units (HPUs), etc.) are configured to execute instructions stored in memories 220. The processors 212 can be a single processing unit or multiple processing units in a device or distributed across multiple devices (e.g., distributed across two or more of client device 110). The processors 212 can be coupled to other hardware devices, for example, with the use of an internal or external bus, such as a PCI bus, SCSI bus, wireless connection, and/or the like. The processors 212 can communicate with a hardware controller for devices, such as input device 214 and output device 216.

Memories 220 includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. Memories 220 is not a propagating signal divorced from underlying hardware; a memory is thus non-transitory. The memories 220 can include program memory that stores programs and software. The memories 220 can also include data memory that can include information to be provided to the program memory or any element of the network.

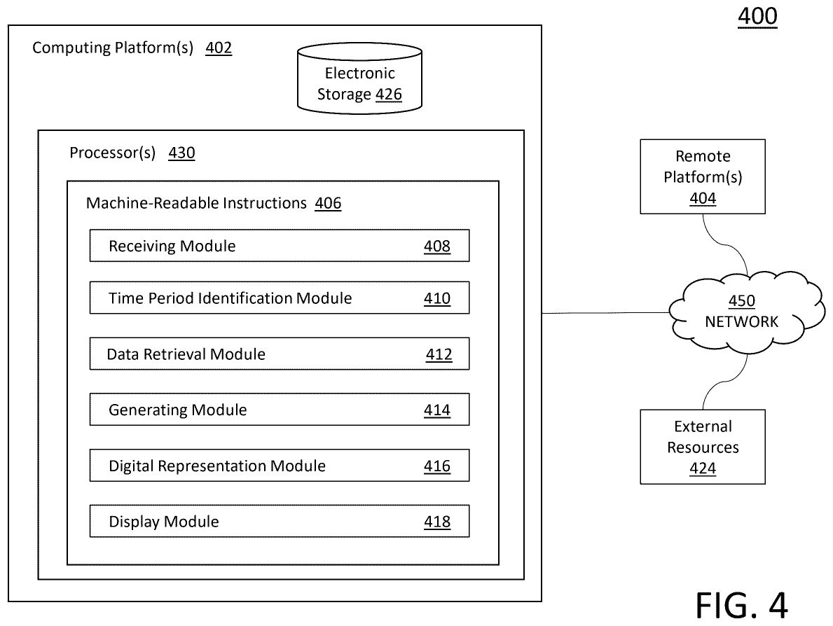

Memory 220-2 may include an engine 232 and an AI tool 234. The engine 232 may share or provide features and resources to display 225, including multiple tools associated with text, image or video collection, capture, design applications that use images or pictures retrieved (e.g., at application 222), content rendering to a user of client device 110. The user may access information from engine 232 through application 222, installed in a memory 220-1 of client device 110. Accordingly, application 222, including display 225, may be installed by servers 130 and perform scripts and other routines provided by servers 130 through any one of multiple tools. Servers 130 may include an application programming interface (API) layer, which controls applications in the client device 110. API layer may also provide tutorials to users of the client device 110 as to new features in the application 222. Engine 232 may include one or more set of machine-readable instruction modules (e.g., modules later described with reference to system 400 in FIG. 4) that, when executed by processors 212, are configured to perform operations according to one or more aspects of embodiments described herein. For example, the engine 232 may be configured to generate a digital representation of the target person in a moment of time based on input data using a generative AI model trained at AI tool 234. As another example, engine 232 may be configured to manage an interactive messaging platform that enables users to engage in dialogue with an automated agent based on the digital representation. The interactive messaging platform may be provided to the users via application 222.

The AI tool 234 may be part of one or more machine learning models stored in the database(s) 152. In some embodiments, at least one or more training archives or machine learning models may be stored in either one of memories 220. The database(s) 152 includes training archives and other data files that may be used by engine 232 in the training of a machine learning model, according to the input of the user through application 222 and data extracted through the network 150.

The AI tool 234 may include algorithms trained for the specific purposes of the engine 232 and tools included therein. The algorithms may include machine learning or artificial intelligence algorithms making use of any linear or non-linear algorithm, such as a neural network algorithm, or multivariate regression algorithm. In some embodiments, the machine learning model may include an LLM, Natural Language Understanding (NLU) model, a neural network (NN), a convolutional neural network (CNN), a generative adversarial neural network (GAN), an unsupervised learning algorithm, a deep recurrent neural network (DRNN), a classic machine learning algorithm such as random forest, or any combination thereof. More generally, the machine learning model may include any machine learning model involving a training step and an optimization step. In some embodiments, the database(s) 152 may include a training archive to modify coefficients according to a desired outcome of the machine learning model. Accordingly, in some embodiments, engine 232 is configured to access database(s) 152 to retrieve data and archives as inputs for the machine learning model. In some embodiments, engine 232, the tools contained therein, and at least part of database(s) 152 may be hosted in a different server that is accessible by servers 130 or client device 110.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

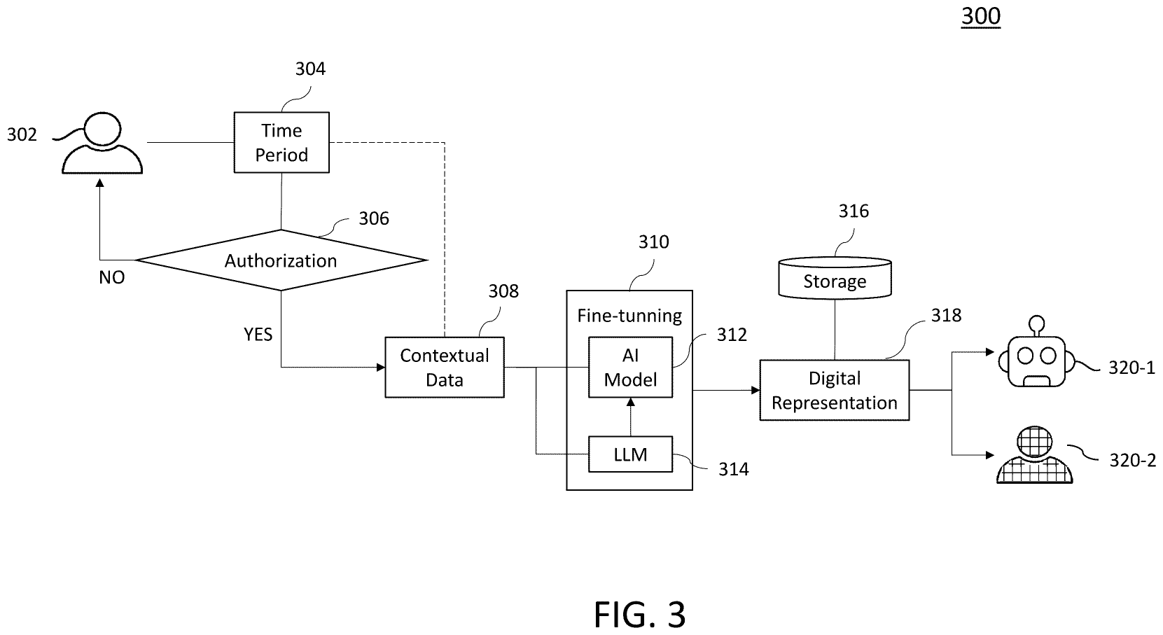

FIG. 3 is a block diagram illustrating an overview 300 of operations for generating digital representation related to a user, according to one or more embodiments. The operations described in FIG. 3 may be performed by one or more of the components detailed in FIG. 2. By non-limiting example, at least a portion of the operations may be performed at a client device or at a server.

According to embodiments, a user 302 may submit a request for generating a digital representation of a target person. The target person may be the same as the user 302. In some implementations, the target person is another user different from the user 302. By non-limiting example, the target person may be a child or elder that the user 302 wants to capture and store a digital representation for. The request may be submitted at a device (e.g., client device 110) of the user 302 and transmitted to a computing platform (e.g., of server 130).

A time period 304 may be identified based on the request. The time period may correspond to a range of dates in the past, present, or future. The time period 304 may be specified by the user 302 in the request. In some embodiments, a time period is determined based on one or more attributes of the request. By non-limiting example, the user 302 may want to create a digital representation of themselves now (i.e., a current time). Based on such a request, a predetermined time period may be set automatically (e.g., a three-month time period preceding the current time) to provide adequate contextual information (e.g., speech, personality, and mannerisms) for generating a digital representation of the user 302 in a present time. By non-limiting example, the user 302 may want to create a digital representation of themselves at a specified age. Accordingly, a time period spanning the year the user 302 was of the specified age may be used.

The user 302 may be required to provide authorization 306 for access to user data based on the time period 304. When authorization 306 has not been provided (NO at authorization 306), the user 302 may be prompted to enable access to target person (and/or user) related data including, but not limited to, media content, contextual information, and/or text data (e.g., messages, chat messages, comments, search, etc.), of the target person restricted to the specified time period. As such, a generated digital representation may be created to reflect the target person based on information retrieved by the user (e.g., associated with the target person) during the time period. In some embodiments, digital representation generation is implemented within a social platform or the like wherein users create account/profiles. As such, users may give general authorization for future access to data based on identified time periods when creating accounts/profiles in the social platform and operations would proceed to retrieving contextual data 308.

Based on authorization 306 being provided (YES at authorization 306), contextual data having a time stamp within the time period is obtained from, for example, the user device or one or more external sources. Contextual data may include content items that can be any digital data such as video, image, audio, text (e.g., from messages, emails, etc.), links, webpages, minutia (e.g., indicia provided from a client device such as emotion indicators, status text snippets, location indictors, etc.), or other multi-media. According to some embodiments, data is extracted from the content items to acquire a deeper understanding of the target person. By non-limiting example, the contextual data may include photos and videos of the target person. The photos and videos may be analyzed to determine mannerisms and characteristics of the target person which is extracted and included in the contextual data.

Subjects and concepts, in the context of a social graph, comprise nodes that represent any person, place, thing, or idea. A social networking system can enable a user to enter and display information related to the target person's (or the user's) interests, age/date of birth, location (e.g., longitude/latitude, country, region, city, etc.), education information, life stage, relationship status, name, a model of devices typically used, languages identified as ones the target person is familiar with, occupation, contact information, or other demographic or biographical information in the user's profile. Any such information can be represented, in various implementations, by a node or edge between nodes in the social graph. In some implementations, content items include input data based on user presence on the social platform. In various implementations, content items can be social network items or parts of social network items, such as posts, likes, mentions, news items, events, shares, comments, messages, other notifications, etc.

The social network may run various applications (i.e., social media applications). As such, data about how a person speaks and interacts with their environment (virtually and otherwise) is obtained and used to train an AI model to understand the target person. In some embodiments, data associated with the target person is retrieved from other users including, but not limited to, family members, users that have an established connections with the target person within the context of the social networking system, and/or other data publicly available (e.g., on the social network). In addition to explicitly establishing a connection in the social networking system, users with common characteristics can be considered connected (such as a soft or implicit connection) for the purposes of determining social context for the target person.

In some embodiments, contextual data includes sensor data input from one or more external systems/devices. By non-limiting example, an external device may be used to scan or capture the target person including their movements, gait, mannerisms, expressions, etc. The external devices may include, but is not limited to, other devices connected to an account of the user 302, a camera, LIDAR device, audio input device, VR/AR headset, smart glasses, etc.

In some embodiments, the target person may be prompted to complete a personality questionnaire/assessment, a set of tasks that may be monitored at the user device (or an external/secondary device), or the like. In some implementations, the user 302 is prompted to complete the personality questionnaire/assessment or set of tasks on behalf of the target person. The contextual data may include responses to the personality questionnaire/assessment and/or data captured from the target person performing the set of tasks which helps refine a base AI model and LLM to the target person. In some embodiments, the questionnaire/assessment may request at least a portion of auditory responses, text responses, actions, or any combination thereof. For example, the target person may be asked to read text aloud, answer a series of questions (general or about themselves), or perform an action such as a movement (e.g., turn your head, wave your hand, etc.), gesture, or posture.

In some embodiments, contextual data includes demographic information. Training based on demographic data allows the base AI model and LLM to anticipate vocabulary, common phrases, accents, or the like.

The retrieved contextual data is then input to the AI model 312 and LLM 314 for fine-tunning 310 based on the target person's contextual data. The AI model 312 and LLM 314 may be pretrained base models. The AI model may be a generative AI model trained on large text/image datasets, publicly available data sources (online or device specific), user metadata, etc. In some embodiments, all the obtained textual data is used to fine-tune the LLM 314 and all visual data is used to fine-tune the AI model 312. The fine-tunning 310 on target person specific contextual data retrieved from the time period 304 is used to generate digital representations with improved quality and fidelity to the target person. In this manner, base models are further trained (e.g., at fine-tunning 310) based on contextual data to represent the target person in the identified time period.

The fine-tuned AI model 312 and LLM 314 generate a digital representation 318 of the target person within the identified time period. The digital representation is a visual of a time slice model of the target person that may be interacted with. The digital representation 318 may include physical characteristics of the target person. The digital representation 318 is generated based on a trained model that understands the target person's mannerisms and personality. As such, the digital representation 318 represents a virtual version of the target person in a slice of time and is configured to predict actions and responses to queries based thereon. By combining machine learning techniques and leveraging the LLM with context-based content retrieval, embodiments achieve improved response generation, ensuring better adaptability, and flexibility in identifying characteristics of the target person and delivering accurate and contextually appropriate responses through a generated digital representation.

The digital representation 318 may be stored in storage 316. The storage 316 may be the same or different from database 152. The digital representation 318 may be stored in association with an account/profile. The digital representation 318 may be stored in connection with the time period as a virtual version of the target person. The user 302 may access the virtual version via the social platform (e.g., via a messaging application to interact with the digital representation). In some implementations, the user 302 may grant access to the virtual version to one or more other users including, but not limited to, the target person. In some embodiments, access to the virtual representation may be restricted based on one or more factors (e.g., time, access code/passcode, relationship to the user 302, etc.).

The digital representation 318 may be displayed to the user 302 (and similarly to the one or more users with access) via a display or user interface of, for example, the user device. In some implementations, the user 302 may interact with the displayed digital representation 318 as a chatbot 320-1. According to embodiments, the chatbot 320-1 may be an AI conversational agent. Users may engage in dialogue with the AI conversational agent in a messaging application/interface. The chatbot 320-1 generates text outputs in response to text inquiries. Users may interact with the version of the target person through text prompts/inquiries in a message thread with the chatbot 320-1. The chatbot 320-1 may be provided in the image of the target person. As such, the chatbot 320-1 appears like the target person, providing a chat character that looks and responds like the target person would have in the time period identified for generating the corresponding digital representation.

In some embodiments, the digital representation generation, leverages photorealistic avatar generation to enable the user 302 to interact with the displayed digital representation 318 as an avatar 320-2 in a virtual environment. The avatar 320-2 may physically look like the target person, embody mannerisms of the target person, and respond like the target person. In some embodiments, the display of the digital representation 318 may be a hologram or a model in an AR environment or MR environment.

The display of the digital representation 318 is not limited to physical appearance and text output. In some embodiments, the digital representation may include text-audio outputs. The audio may be based on the target person's tone, cadence, and/or demographic information of the target person. The displays of the digital representation 318 (e.g., chatbot 320-1 and avatar 320-2) may be configured to move according to the text or audio output. As such, it looks, sounds, and feels like the target person is speaking.

According to some embodiments, contextual data may be retrieved from one or more data sources. In particular embodiments, one or more objects (e.g., content items or other types of contextual data and/or models for accessing interactive digital representations) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof.

A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-account/profile page that identifies a set of users that may access generated digital representations on the user-account/profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. As such, the photo may be used as contextual data if the target person is tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a first user (e.g., user 302) may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

FIG. 4 is a block diagram illustrating an example computer system 400 (e.g., representing both client and server) with which aspects of the subject technology can be implemented. The system 400 may be configured for generating time-based interactive digital representations of a subject, according to certain aspects of the disclosure. In some implementations, the system 400 may include one or more computing platforms 402. The computing platform(s) 402 can correspond to a server component of a mixed reality, AR, or XR platform or other communication platform, which can be similar to or the same as the server 130 of FIG. 2 and include the processor 212. For example, the computing platform(s) 402 may be configured to execute software algorithm(s) to generate a digital representation and predict actions, responses, etc., to be output using the generated digital representation.

The computing platform(s) 402 can maintain or store data, such as in the electronic storage 426, including correlation and contextual data used by the computing platform(s) 402. The computing platform(s) 402 may be configured to communicate with one or more remote platforms 404 according to a client/server architecture, a peer-to-peer architecture, and/or other architectures. The remote platform(s) 404 may be configured to communicate with other remote platforms via computing platform(s) 402 and/or according to a client/server architecture, a peer-to-peer architecture, and/or other architectures. Users may access the system 400 by hosting one or more of application(s) or XR environment via remote platform(s) 404. In this way, the remote platform(s) 404 can be configured to cause output of the system 400 on client device(s) of the remote platform(s) 404 with enabled access (e.g., based on analysis by the computing platform(s) 402 according to the stored data).

The computing platform(s) 402 may be configured by machine-readable instructions 406. The machine-readable instructions 406 may be executed by the computing platform(s) to implement one or more instruction modules. The instruction modules may include computer program modules. The instruction modules being implemented may include one or more of receiving module 408, time period identification module 410, data retrieval module 412, generating module 414, digital representation module 416, display module 418, and/or other instruction modules.

The receiving module 408 may be configured to receive, at a user device, a request for generating time-slice digital representation of a subject (e.g., target person). The request may specify the subject. The request may be made through a user account logged in at the user device. The user account may be for a social network or one or more application(s) therein. Credentials may be required to gain access to the user account and/or contents stored in association with the user account. In some embodiments, a user submitting the request is the same as the subject. In some embodiments, the user submitting the request is different from the subject. By non-limiting example, the user may want to generate a digital representation of another person (i.e., a target person).

In some embodiments, the system 400 determines that a digital representation should be created based on one or more attributes of the user and automatically initiates generation of the digital representation. In some implementations, the system 400 provides the user with a suggestion for generating the digital representation. The one or more attributes of the user may include, but are not limited to, an influx of contextual data at the user device, a determination of a major event or milestone (e.g., graduation, birthday, funeral, birth, etc.) based on user data, or the like.

Time period identification module 410 may be configured to determine a time period covering a time span associated with the request. The time period may be a present period of time, a past period of time, or future period of time. By non-limiting example, the request may be to create a predicted digital representation of the user in 10 years. In some embodiments, the time period is specified in the request by the user. In some embodiments, the time period is automatically generated based on an analysis of the request.

Data retrieval module 412 may be configured to retrieve contextual data associated with the subject based on the time period. The contextual data is restricted to data within the time period. The data retrieval module 412 may identify the contextual data for retrieval based on a timestamp of the content item or contextual information. As discussed herein, the contextual data may be obtained from one or more external data sources (e.g., external resources 424) associated with the user or user account. In some embodiments, the system 400 generates a questionnaire for identifying personality and characteristics of the subject, and further utilizing responses from the questionnaire as contextual data retrieved by the data retrieval module 412. The contextual data may be stored in the electronic storage 426.

In some embodiments, the data retrieval module 412 identifies physical operations that, when performed by the subject, are used to determine physical characteristics of the subject (e.g., expressions, movements, gait, etc.). The data retrieval module 412 can be in communication with one or more devices of the remote platforms(s) 404 configured to capturing an image or video depicting the subject performing the physical operation. In some implementations, capturing the subject may include scanning the subject for data on physical appearance (with or without a specified physical operation being performed).

In some embodiments, the user is requested to provide authorization for access to the contextual data based on the time period. Users may provide general authorization or request specific authorization for each request made.

Generating module 414 may be configured to generate, based on the contextual data, a model representing the subject. The model may be comprised of one or more of a trained generative AI model and LLM. The generative AI model may be fine-tuned based on contextual data to generate physical characteristics of the subject including, but not limited to, actions, movement, mannerisms, etc. The LLM may be fine-tuned based on contextual data to generate contextually faithful text based on the subject (e.g., appropriately reflecting personality and diction). In some implementations, the model is configured to predict an appearance of the subject in view of the contextual data based on the time period being a future time period (e.g., aging the subject based on the time period). The model may be stored in the electronic storage 426 in association with the user account, the contextual data, or the like. In some implementations, a code is required to gain access to the model stored in association with the user account. Accordingly, system 400 can determine, analyze, store, host, send, receive, or otherwise manipulate contextual data for generating person-specific time-based models.

In some implantations, the system 400 may leverage an existing model of the subject (obtained from the electronic storage 426) based on the request being related to another request to further fine-tune the existing model with new parameters. By non-example, when a time period of a first request matches, with a predetermined degree of overlap, a time period of a second request, a model generated from the first request may be updated or modified when generating a model for the second request.

Digital representation module 416 may be configured to generate an interactive digital representation based on the model. In some implementations, the digital representation may include a chatbot to be implemented in a messaging application. The system 400 may generate a message thread facilitating a conversation between the user and the chatbot of the subject. The system 400 may receive text queries input from the user in the message thread and generate predicted responses to the text queries based on the model of the subject. In some implementations, the digital representation may include an avatar that users may interact with in an XR environment.

Display module 418 may be configured to display the digital representation (e.g., at the user device) to a user interface. For example, the display module 418 may render at least a portion of the digital representation (e.g., a 3D portrait in an image of the subject within the message thread). In some implementations, a full body is rendered in the digital representation. The display module 418 may be further configured to output the predicted responses to the text queries in the message thread in a conversation format. The display module 418 may be further configured to render the model as an avatar in a virtual environment wherein the avatar's physical appearance matches an appearance of the subject during the time period.

According to some embodiments, system 400 is further configured to extract audio from the contextual data to determine voice, speech, pattern, and audio information applying the audio information of the subject for the time period. The audio information may be applied to the model. As such, the digital representation module 416 may generate the digital representation to reflect an appearance of the subject, as well as speech patterns of the subject and audio outputs corresponding to a voice of the subject based on the model.

According to some embodiments, system 400 is further configured to track the generated models. Digital representations of the generated models may be organized based on temporal information. For example, the digital representations may be organized and displayed in a timeline format including navigation or communication actions, such as scrollbars, arrow keys, model/digital representation selections or commands, and/or the like. Each model/digital representation may correspond to an indicator on the timeline. Users may choose to interact with digital representations across the timeline and make selections using the timeline display. For example, the user may select a digital representation of themselves from 10 years ago, activate that model, and proceed to interact with the digital representation by asking questions or the like.

According to some embodiments, the request may be for generating a digital representation of “a day in a life” of a subject. Accordingly, the digital representation may be a virtual interactive experience such that the user may explore, visualize, and interact in a virtual environment in view of the subject or alongside the subject.

In some implementations, the computing platform(s) 402, the remote platform(s) 404, and/or the external resources 424 may be operatively linked via one or more electronic communication links. For example, such electronic communication links may be established, at least in part, via the network 450 (e.g., network 150) such as the Internet and/or other networks. It will be appreciated that this is not intended to be limiting, and that the scope of this disclosure includes implementations in which the computing platform(s) 402, the remote platform(s) 404, and/or the external resources 424 may be operatively linked via some other communication media.

A given remote platform 404 may include client computing devices, such as the client device 110, which may each include one or more processors configured to execute computer program modules (e.g., the instruction modules). The computer program modules may be configured to enable an expert or user associated with the given remote platform 404 to interface with the system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms. The external resources 424 may include sources of information outside of the system 400, external entities participating with the system 400, and/or other resources. For example, the external resources 424 may include externally designed XR elements and/or XR applications designed by third parties. In some implementations, some or all of the functionality attributed herein to the external resources 424 may be provided by resources included in system 400.

Computing platform(s) 402 may include electronic storage 426, one or more processors 430, and/or other components. Computing platform(s) 402 may include communication lines, or ports to enable the exchange of information with a network and/or other computing platforms. Illustration of the computing platform(s) 402 in FIG. 4 is not intended to be limiting. The computing platform(s) 402 may include a plurality of hardware, software, and/or firmware components operating together to provide the functionality attributed herein to the computing platform(s) 402. For example, the computing platform(s) 402 may be implemented by a cloud of computing platforms operating together as the computing platform(s) 402.

Electronic storage 426 may comprise non-transitory storage media that electronically stores information. The electronic storage media of electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426 may include one or more virtual storage resources (e.g., cloud storage, a virtual private network, and/or other virtual storage resources). Electronic storage 426 may store software algorithms, information determined by processor(s) 430, information received from computing platform(s) 402, information received from remote platform(s) 404, and/or other information that enables computing platform(s) 402 to function as described herein.

Processor(s) 430 may be configured to provide information processing capabilities in computing platform(s) 402. As such, processor(s) 430 may include one or more of a digital processor, an analog processor, a digital circuit designed to process information, an analog circuit designed to process information, a state machine, and/or other mechanisms for electronically processing information. Although processor(s) 430 is shown in FIG. 4 as a single entity, this is for illustrative purposes only. In some implementations, processor(s) 430 may include a plurality of processing units. These processing units may be physically located within the same device, or processor(s) 430 may represent processing functionality of a plurality of devices operating in coordination. Processor(s) 430 may be configured to execute modules 408, 410, 412, 414, 416, and/or 418, and/or other modules. Processor(s) 430 may be configured to execute modules 408, 410, 412, 414, 416, and/or 418, and/or other modules by software; hardware; firmware; some combination of software, hardware, and/or firmware; and/or other mechanisms for configuring processing capabilities on processor(s) 430. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, and/or 418 are illustrated in FIG. 4 as being implemented within a single processing unit, in implementations in which processor(s) 430 includes multiple processing units, one or more of modules 408, 410, 412, 414, 416, and/or 418 may be implemented remotely from the other modules. The description of the functionality provided by the different modules 408, 410, 412, 414, 416, and/or 418 described below is for illustrative purposes, and is not intended to be limiting, as any of modules 408, 410, 412, 414, 416, and/or 418 may provide more or less functionality than is described. For example, one or more of modules 408, 410, 412, 414, 416, and/or 418 may be eliminated, and some or all of its functionality may be provided by other ones of modules 408, 410, 412, 414, 416, and/or 418. As another example, processor(s) 430 may be configured to execute one or more additional modules that may perform some or all of the functionality attributed below to one of modules 408, 410, 412, 414, 416, and/or 418.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

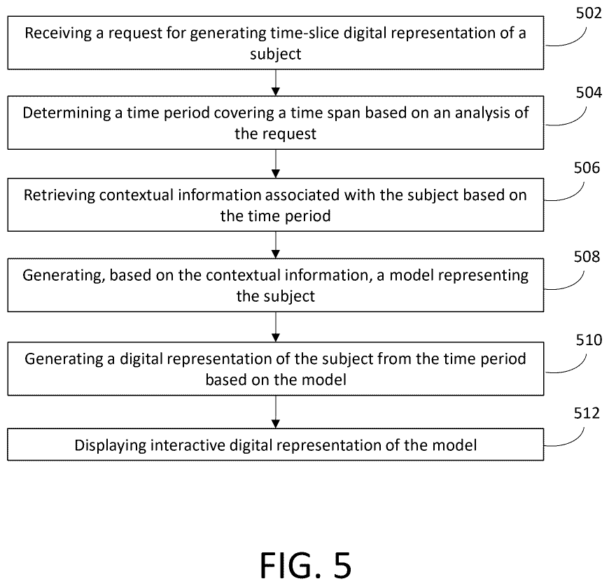

FIG. 5 illustrates an example flow diagram (e.g., process 500) for generating time-based interactive digital representations, according to certain aspects of the disclosure. For explanatory purposes, the example process 500 is described herein with reference to one or more of the figures above. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to one or more of the figures above.

At step 502, the process 500 may include receiving a request for generating time-slice digital representation of a subject. According to an aspect of embodiments, the request may be made by the subject or another user. At step 504, the process 500 may include determining a time period covering a time span based on an analysis of the request. According to an aspect of embodiments, the time period may be a present period of time, a past period of time, or future period of time.

At step 506, the process 500 may include retrieving contextual information associated with the subject based on the time period. The contextual information may be determined as any digital data comprising a timestamp within the time period. According to an aspect of embodiments, users are requested to provide authorization for access to the contextual information at the client device based on the time period. That is, access to all digital data within the time period. According to an aspect of embodiments, digital data includes, but is not limited to, video, audio, image, text, social presence, etc. According to an aspect of embodiments, determining the contextual information includes obtaining image, video, and text data from one or more external data sources associated with a user account corresponding to the request. According to an aspect of embodiments, retrieving contextual information includes generating a physical operation for identifying physical characteristics of the subject and capturing an image or video depicting the subject performing the physical operation. According to an aspect of embodiments, retrieving contextual information includes generating a questionnaire for identifying a personality of the subject and receiving user response to the questionnaire.

At step 508, the process 500 may include generating, based on the contextual information, a model representing the subject. The model is trained on the contextual information to predict characteristics of the subject within the time period including, but not limited to, an appearance, mannerisms, and personality of the subject, speech patterns of the subject, and audio corresponding to a voice of the subject, to further predict actions and responses based on the model. According to an aspect of embodiments, the model is stored in association with the user account, wherein user credentials are required to gain access to the user account. According to an aspect of embodiments, the stored model may be activated and interacted with (via a corresponding digital representation) at a later time.

At step 510, the process 500 may include generating a digital representation of the subject from the time period based on the model. The digital representation may be an interactive object such as a chatbot or avatar that looks, sounds, responds, and/or acts (e.g., through movements and facial expressions) like the subject in the time period.

At step 512, the process 500 may include displaying interactive digital representation of the model. According to an aspect of embodiments, displaying the interactive digital representation includes generating a message thread between a user of the client device and the digital representation. In some embodiments, a contact is created at the user's device and the digital representation is saved therefrom for later interactions and/or conversations. According to an aspect of embodiments, displaying the interactive digital representation includes rendering at least a portion of the model in an image of the subject within the message thread. The user may input text queries in the message thread. The process 500 may further include receiving the input text queries and generating predicted responses to the text queries based on the model of the subject. The predicted responses to the text queries may be output in the message thread in a conversation format. According to an aspect of embodiments, displaying the interactive digital representation includes rendering the model as an avatar in a virtual environment wherein the avatar's physical appearance matches an appearance of the subject during the time period.

### Hardware Overview

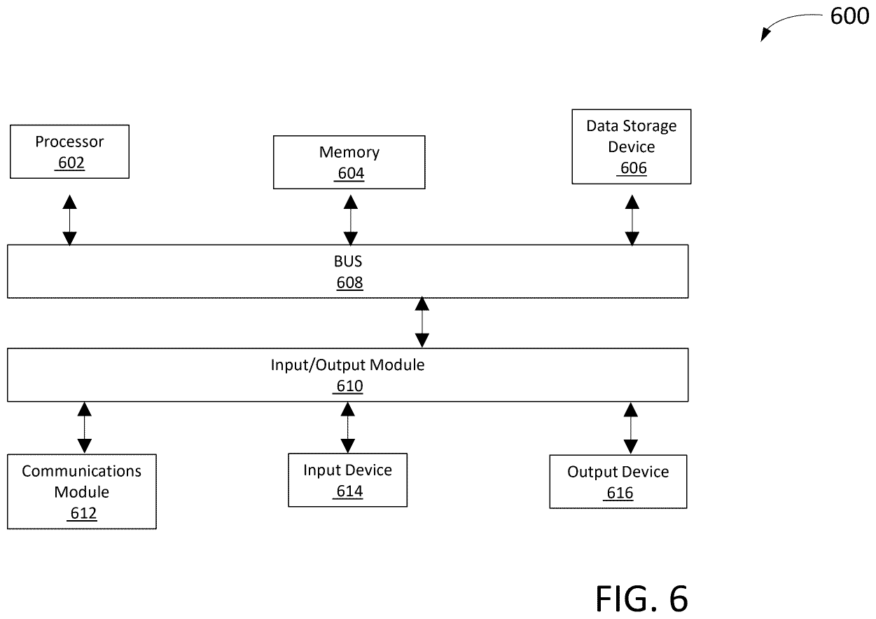

FIG. 6 is a block diagram illustrating an exemplary computer system 600 with which the client and server of FIGS. 1-5, and method(s) described herein can be implemented. In certain aspects, the computer system 600 may be implemented using hardware or a combination of software and hardware, either in a dedicated server, or integrated into another entity, or distributed across multiple entities. Computer system 600 may include a desktop computer, a laptop computer, a tablet, a phablet, a smartphone, a feature phone, a server computer, or otherwise. A server computer may be located remotely in a data center or be stored locally.

Computer system 600 includes a bus 608 or other communication mechanism for communicating information, and a processor 602 (e.g., processors 212) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memory 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variables or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications module 612 (e.g., communications module 218) include networking interface cards, such as Ethernet cards and modems. In certain aspects, input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output device 616 include display devices, such as an LCD (liquid crystal display) monitor, for displaying information to the user.

According to one aspect of the present disclosure, the client device and server can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set-top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for generating time-based models, the method comprising:
receiving a request, at a client device, specifying a subject;
determining a time period covering a time span associated with the request;
retrieving, from at least the client device, contextual information including at least text data associated with the subject, the contextual information restricted by the time period;
generating, based on the contextual information, a model representing characteristics of the subject; and
displaying an interactive digital representation of the model in a user interface of the client device.

2. The computer-implemented method of claim 1, wherein determining the contextual information comprises:
obtaining image, video, and text data from one or more external data sources associated with a user account, wherein the request is made through the user account; and
storing the model in association with the user account, wherein user credentials are required to gain access to the user account.

3. The computer-implemented method of claim 1, further comprising:
generating a physical operation for identifying physical characteristics of the subject; and
capturing an image or video depicting the subject performing the physical operation, the image or video depicting the subject included in the contextual information.

4. The computer-implemented method of claim 1, wherein retrieving contextual information further comprises:
generating a questionnaire for identifying a personality of the subject; and
receiving user input in response to the questionnaire, the user input included in the contextual information.

5. The computer-implemented method of claim 1, wherein the time period is specified by a user in the request.

6. The computer-implemented method of claim 1, further comprising requesting authorization for access to the contextual information at the client device based on the time period.

7. The computer-implemented method of claim 1, wherein the time period is made up of a present, past, or future period of time.

8. The computer-implemented method of claim 1, wherein the model reflects an appearance of the subject, and includes speech patterns of the subject and audio outputs corresponding to a voice of the subject.

9. The computer-implemented method of claim 1, wherein displaying the interactive digital representation further comprises:
generating a message thread in a social platform between a user of the client device and the interactive digital representation;
rendering at least a portion of the interactive digital representation in an image of the subject within the message thread;
receiving text queries input by the user into the message thread;
generating predicted responses to the text queries based on the model of the subject; and
outputting the predicted responses to the text queries in the message thread in a conversation format.

10. The computer-implemented method of claim 1, wherein displaying the interactive digital representation further comprises rendering the model as an avatar in a virtual environment wherein a physical appearance of the avatar matches an appearance of the subject during the time period.

11. A system for generating time-based models, comprising:
one or more processors; and
a memory comprising instructions stored thereon, which when executed by the one or more processors, causes the one or more processors to:
receive a request, at a client device, specifying a subject;
determine a time period covering a time span associated with the request,
wherein the time period is made up of a present, past, or future period of time;
retrieve, from at least the client device, contextual information including at least text data associated with the subject, the contextual information restricted by the time period;
generate, based on the contextual information, a model representing characteristics of the subject; and
display an interactive digital representation of the model in a user interface of the client device.

12. The system of claim 11, wherein the one or more processors are further configured to:
obtain image, video, and text data from one or more external data sources associated with a user account, wherein the request is made through the user account; and
store the model in association with the user account, wherein user credentials are required to gain access to the user account.

13. The system of claim 11, wherein the one or more processors are further configured to:
generate a physical operation for identifying physical characteristics of the subject; and
capture an image or video depicting the subject performing the physical operation, the image or video depicting the subject included in the contextual information.

14. The system of claim 11, wherein the one or more processors are further configured to:
generate a questionnaire for identifying a personality of the subject; and
receive user input in response to the questionnaire, the user input included in the contextual information.

15. The system of claim 11, wherein the time period is specified by a user in the request.

16. The system of claim 11, wherein the one or more processors are further configured to request authorization for access to the contextual information at the client device based on the time period.

17. The system of claim 11, wherein the model reflects an appearance of the subject, and includes speech patterns of the subject and audio outputs corresponding to a voice of the subject.

18. The system of claim 11, wherein the one or more processors are further configured to:
generate a message thread in a social platform between a user of the client device and the interactive digital representation;
render at least a portion of the interactive digital representation in an image of the subject within the message thread;
receive text queries input by the user into the message thread;
generate predicted responses to the text queries based on the model of the subject; and
output the predicted responses to the text queries in the message thread in a conversation format.

19. The system of claim 11, wherein the one or more processors are further configured to render the model as an avatar in a virtual environment wherein a physical appearance of the avatar matches an appearance of the subject during the time period.

20. A non-transitory computer-readable storage medium comprising instructions stored thereon, which when executed by one or more processors, cause the one or more processors to perform operations for generating time-based models, comprising:
receiving a request, at a client device, specifying a subject;
determining a time period covering a time span associated with the request, wherein the time period is made up of a present, past, or future period of time;
retrieving, from at least the client device, contextual information including at least text data associated with the subject, the contextual information restricted by the time period;
generating, based on the contextual information, a model representing characteristics of the subject; and
displaying an interactive digital representation of the model in a user interface of the client device, wherein the interactive digital representation is configured to generate responses to text queries in accordance with predications made based on the model.
